(19) United States
(12) Patent Application Publication
(10) Pub. No.: US 2010/0237680 A1
(43) Pub. Date: Sep. 23, 2010

(54) LOOP CHAIR

(76) Inventor: William Pedersen, New York, NY (US)

Correspondence Address: OSTROLENK FABER GERB & SOFFEN, 1180 AVENUE OF THE AMERICAS, NEW YORK, NY, 100368403, US

(21) Appl. No.: 12/716,861

(22) Filed: Mar. 3, 2010

Related U.S. Application Data
(60) Provisional application No. 61/209,176, filed on Mar. 3, 2009.

(51) Int. Cl. A47C 7/02; B68G 7/00

(52) U.S. Cl. 297/452.19; 29/91.1

(57) ABSTRACT

A chair frame is formed of a continuous and endless loop that includes ground engaging loops (or legs), fabric seat receiving loops, which also act as arm rests, and a back loop which defines the chair back. Fabrics are fixed to the seat loops and back loops to form the seat and back respectively of the chair.

### RELATED APPLICATION AND CLAIM OF PRIORITY

This application claims the benefit of U.S. Provisional Application No. 61/209,176, filed Mar. 3, 2009, the entire disclosure of which is incorporated by reference herein.

### FIELD OF THE INVENTION

The present invention relates generally to furniture and, more particularly, to a chair having a frame that is formed from a continuous and endless loop of metal tubing. Endless as used herein indicates that the loop is closed and does not have a free and open end.

### DESCRIPTION OF THE RELATED ART

Furniture comes in many shapes and sizes. In the prior art, furniture and frame for chairs are manufactured by joining several, separate wooden or metal pieces together with nuts, bolts, screws, glue and the like. The pieces are typically sized, cut and then assembled according to a plan, which forms the frame. In the case of chairs, the frame is, thereafter, covered with cushioning, fabric, leather, or the like, to complete the chair.

### BRIEF SUMMARY OF THE PREFERRED EMBODIMENTS

The present invention provides a new form of furniture, including a new furniture frame, which is preferably formed from a continuous and endless loop of metal tubing. In a preferred embodiment, a stainless steel tube or the like body is bent to create an endless loop frame for a chair although virtually any kind of furniture can be made in accordance with the teachings herein. Preferably, the stainless steel tube has a diameter of ⅝ of an inch, but other kinds and sizes of tubing can be used without deviating from the scope and spirit of the present invention.

A variety of chair frames can be realized using the concepts disclosed herein, including, but not limited to, a dining room chair frame, dining room chair frame with an elongated back, a lounge chair frame or a lounge chair frame with an elongated back.

In a preferred embodiment, once the frame is bent according to the desired shape, the frame is at least partially covered with, for example, fabric, leather or other covering hereafter, collectively termed a “fabric”. Preferably, at least some cushioning is also provided for comfort. In a preferred embodiment, a significant portion of the chair frame is exposed, as the frame adds aesthetic value.

The result is stylish, attractive and modern looking furniture, such as chairs, that are formed by bending a single, straight elongated body, a continuous loop formed from an elongated body, or by bending multiple parts into curved pieces and joining the curved pieces.

Thus, in accordance with the invention, an exemplary chair frame is formed from a continuous and elongated body that is bent along its length to form a plurality of continuous loops, the plurality of continuous loops including at least three spaced floor engaging loops and first and second seat receiving loops, and a back receiving loop.

Other features and advantages of the present invention will become apparent from the following description of the invention which refers to the accompanying drawings.

### BRIEF DESCRIPTION OF THE FIGURES

FIG. 1 shows a continuous endless loop formed with a single rod or tube, which can be bent to form loops that define a chair frame for a chair according to an embodiment of the present invention.

FIG. 2A shows the continuous, endless loop of FIG. 1 bent to form a chair frame according to one embodiment of the present invention.

FIGS. 2B-2F illustrate steps in the fabrication of a frame for a chair according to the present invention.

FIGS. 3, 4 and 5 are perspective views of the frame of FIG. 2A, as seen from different angles.

FIGS. 6, 7 and 8 are perspective views from different angles of a second embodiment of the invention, employing a high back, defining, for example, a frame for a dining chair.

FIGS. 9, 10 and 11 are perspective views from different angles of an embodiment of the invention for a lounge chair.

FIGS. 12, 13 and 14 are perspective views of a further preferred embodiment for the frame of a tall lounge chair.

FIG. 15 is a plan view of the frame of FIGS. 12, 13 and 14 with attached seat and back cushioned fabric.

FIG. 16 is a front elevation view of FIG. 15.

FIG. 17 is a side elevation view of FIG. 15.

FIG. 18 is an oblique view from the front of FIG. 5.

FIG. 19 is an oblique rear view of FIG. 15.

FIG. 20 is a front oblique view of FIG. 15.

FIG. 21 is a perspective view of the chair of FIG. 15 with the cushioned fabric replaced by a rubber or leather based fabric.

FIGS. 22A-22D show, respectively, a left-side perspective view, a front view, a bottom view, and a back view of a chair according to another embodiment of the present invention.

FIG. 23A illustrates a left-side perspective view of a chair according to another embodiment of the present invention.

FIG. 23B illustrates one method of assembly of a cord onto the frame of a chair according to the embodiment illustrated by FIG. 23A.

FIG. 23C illustrates another method of assembly of a cord onto the frame of a chair according to the embodiment illustrated by FIG. 23A.

### DETAILED DESCRIPTION OF THE PREFERRED EMBODIMENTS

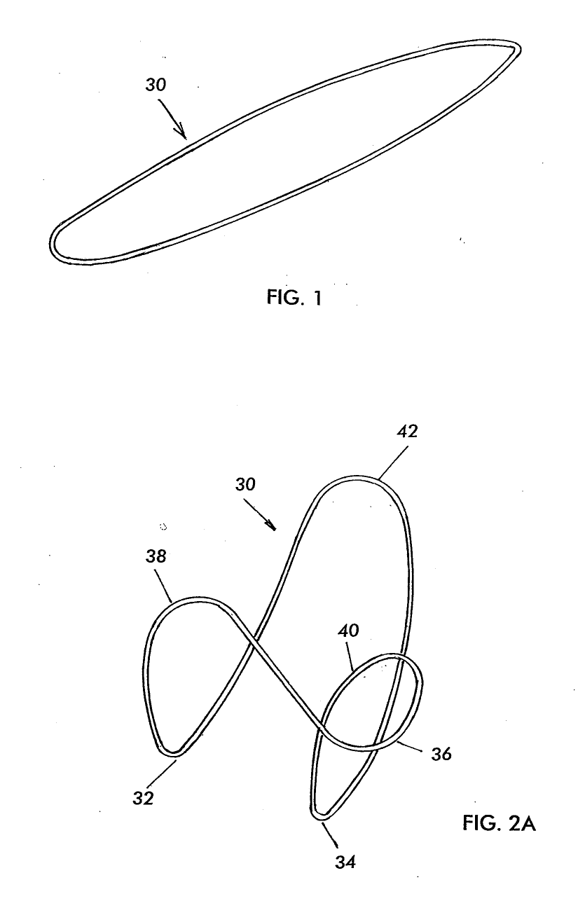

Referring first to FIG. 1, there is shown a continuous and endless loop 30 made preferably of a single rod of material that can be bent, for example, in a conventional bending apparatus to form loops that define a furniture frame with sufficient strength to support a body weight without further permanent bending. A preferred material for loop 30 is stainless steel tubing of outer diameter greater than about 0.5 inch and preferably of diameter ⅝ inch. Other sized hollow tubes or solid rods of stainless steel or other kinds of steel, copper, aluminum, or even plastic can be used without deviating from the scope and the spirit of the present invention. For example, a 1″ stainless steel tube may be a suitable choice with the added benefit of improved lateral stability. Loop 30 may be formed of a single elongated body of one section, or a plurality of sections that are joined by welding, brazing or gluing, and then ultimately closed to obtain loop 30.

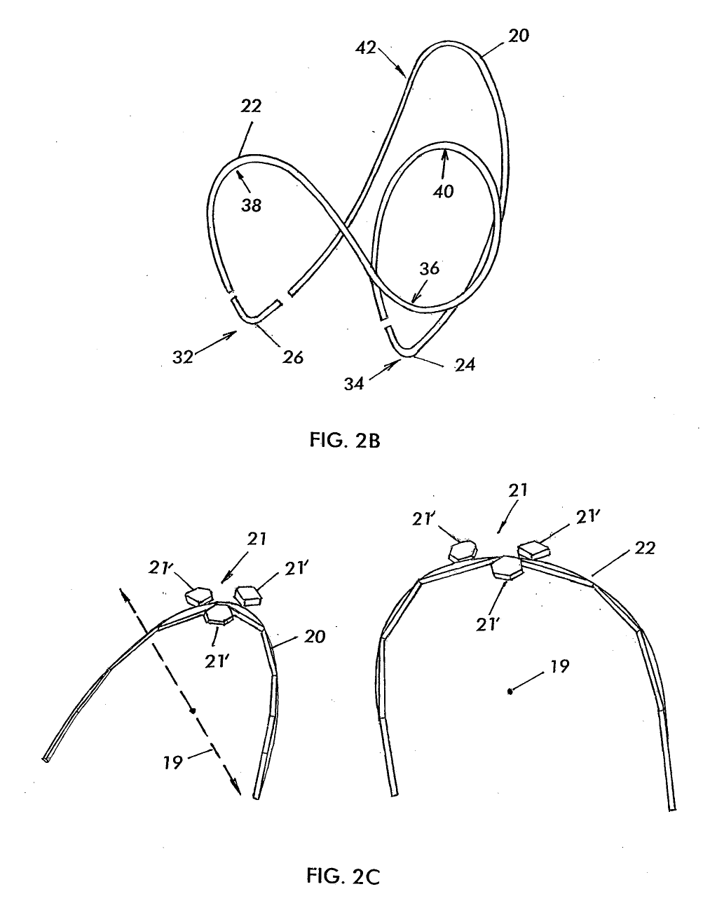

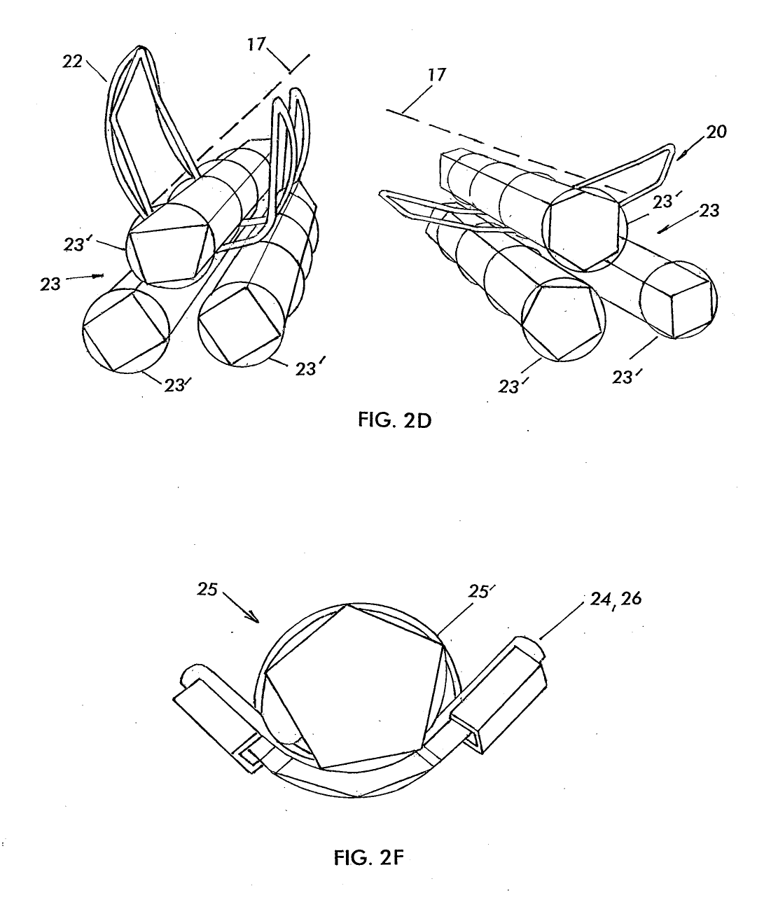

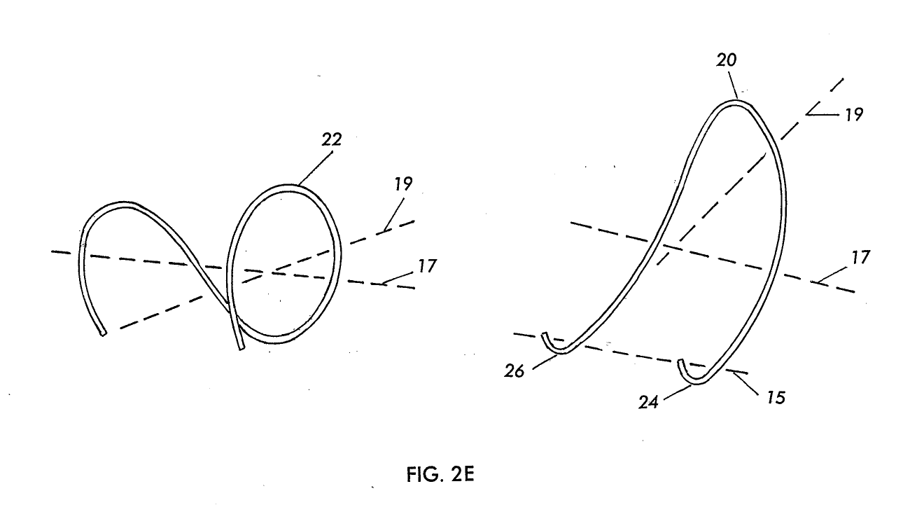

FIG. 2A shows a frame for a chair according to the present invention, which can be fabricated by bending closed loop 30. The frame shown by FIG. 2A includes a plurality of loops, which can be obtained by bending loop 30. Specifically, the frame includes floor—engaging loops 32, 34, 36; seat—receiving loops 38, 40, and back—receiving loop 42. These loops are bent seriatim in a sequence, for example, of loops 32, 38, 36, 40, 34, 42. Note that instead of using loop 30, an elongated body, e.g. a rod or a tube, can be first bent to obtain loops 32, 38, 36, 40, 42 and then the free ends of the elongated body can be joined by, for example, welding, gluing or brazing to obtain the frame depicted by FIG. 2A.

Additional ground engaging loops may be used if desired.

While the loops shown have relatively large radii other shapes can be used. For example, the bottoms of loops 32, 34 and 36 can be sharpened and the seat receiving loops can be flattened at their tops.

While the frame of a chair according to the present invention is visually simple and elegant, it is geometrically complex. The chair's unique torsional spring frame is a constantly changing 3 dimensional curve. In order to accurately produce the chair frame with available metal working machinery, the frame can be constructed from several elements instead of bending loop 30 or bending a single elongated body such as a tube or a rod.

Specifically, referring to FIG. 2B, a frame for a chair according to the present invention can be constructed from four individual curved pieces 20, 22, 24, 26. Curved piece 20 includes the back-receiving loop 42, curved piece 22 is the seat-receiving loop and includes engaging loop 36, and curved pieces 24, 26 include engaging loops 32, 34. Each curved piece 20, 22, 24, 26 can be fabricated by bending a straight, elongated body, such as a tube, and thereafter integrated into a unitary body by welding, gluing or the like with the other curved pieces to realize an endless and closed loop frame as illustrated, for example, in FIG. 2A.

Referring to FIG. 2C, to fabricate curved pieces 20 and 22, a suitable length of a straight, elongated body (e.g. a tube) is bent around a first axis 19 (shown as a point to indicate that the axis is emerging from the plane on which curved body 22 lies) to obtain a generally U-shaped body. Note that first axis 19 is preferably oriented 90° or normal to the plane on which the elongated body lies. Also, it should be noted that a curved body 20, 22 and its associated first axis 19 may not be equidistant at every point along the curved body. Thus, each curved body 20, 22 may have a varying radius of curvature relative to first axis 19 thereof. Preferably, the curved body obtained after the first bending step is symmetrical.

To bend the elongated body into a U-shaped body any method can be used. For example, a three-roll powered bending machine can be used. As is well known, a three-roll bending machine includes three axially aligned and spaced rollers 21′ as depicted in FIG. 2C.

In a second bending step, the curved U-shaped bodies can be treated as if they were flat plates and bent around a second axis 17 parallel to the plane thereof but not parallel to first axis 19 thereof. To carry out the second bending step powered plate rollers can be employed. Referring to FIG. 2D, a typical arrangement of powered plate rollers 23 includes three spaced and axially aligned cylindrical rollers 23′. Each U-shaped piece from the first bending step is then fed into the powered plate roller arrangement as illustrated and bent around a second axis 17 parallel to the plane thereof and incidentally parallel to axes of rollers 23′. The result of the second bending step is curved pieces 20 and 22 as illustrated by FIG. 2E. It should be noted that curved body 20, 22 and its associated second axis 17 may not be equidistant at every point along the curved body. Thus, each curved body 20, 22 may have a varying radius of curvature relative to second axis 17 thereof.

Referring to FIG. 2F, each curved piece 24, 26 can be fabricated by bending a straight elongated body (e.g. a tube) around an axis 15 (see FIG. 2E) 90° or normal to the plane in which the body lies. Thus, for example, a straight elongated body can be bent using a hydraulic tubing bender 25. As is well known, a hydraulic tubing bender 25 includes a center die 25′. A suitable bender includes a 5″ diameter 1″ aluminum center die. Note that in the preferred embodiment, curved pieces 24, 26 are curved around one axis, unlike curved pieces 17 and 19, which curve about two unparallel axis 17 and 19.

Once all curved pieces 20, 22, 24, 26 have been bent and trimmed any secondary operations such as drilling and polishing can take place. Then the joints between curved pieces 20, 22, 24, 26 can be sleeved and welded or otherwise joined. Note that, as illustrated by FIG. 2B, curved pieces 24, 26, act as links to couple curved pieces 20, 22. Thus, one free end of each curved piece 24, 26 is coupled and integrated with a respective free end of one of larger curved pieces 20, 22 to realize a frame for a chair according to the present invention.

In the following description of the drawings, loops similar to loops 32 to 42 have the same identifying numerals.

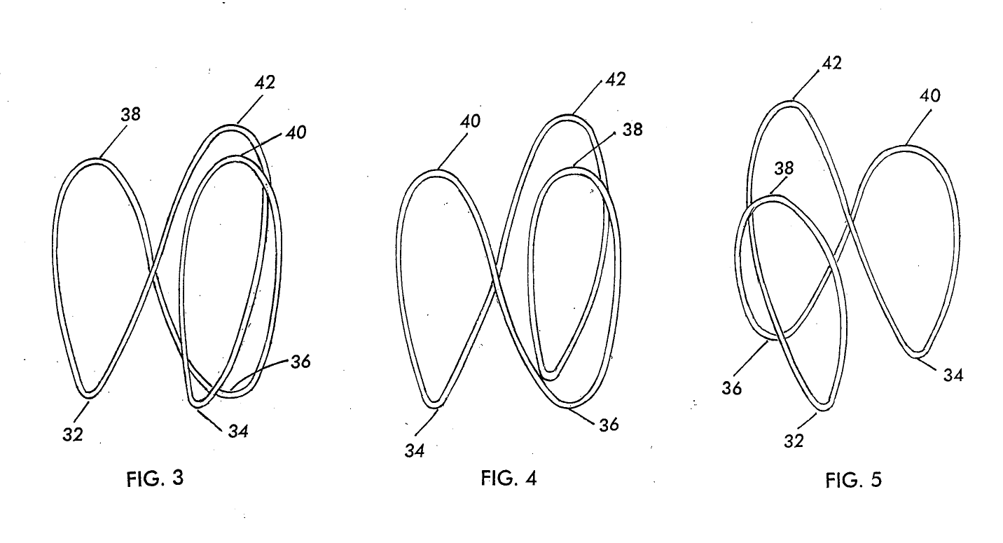

FIGS. 3, 4 and 5 show a chair frame like that of FIG. 2 for a dining chair.

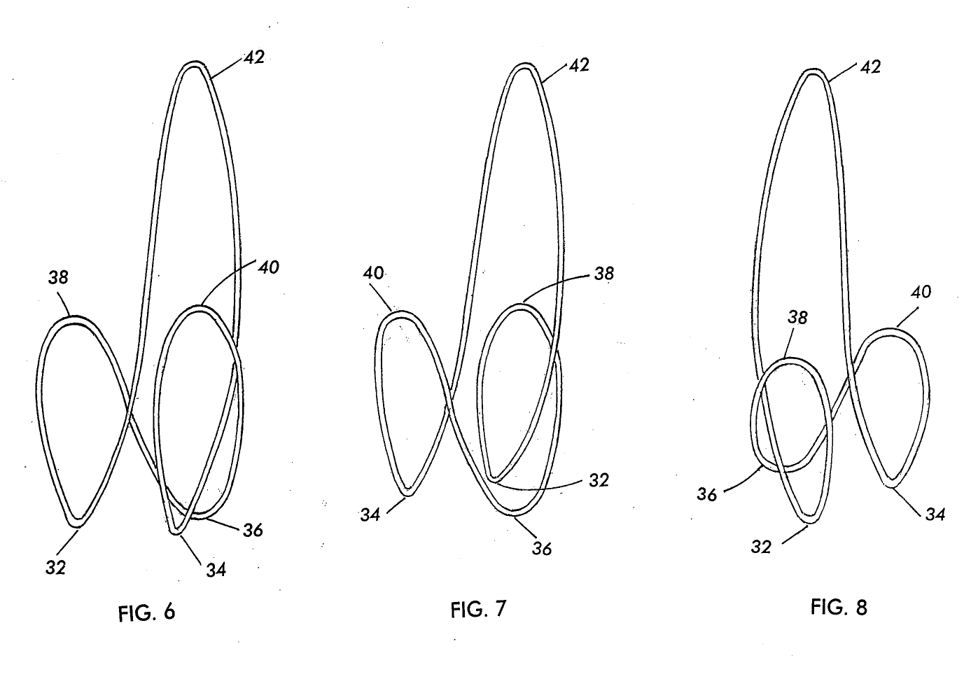

FIGS. 6, 7 and 8 show an embodiment of the chair frame of FIGS. 3, 4 and 5, where, however, the loop 42 is exaggerated in height to form a frame for a tall dining chair.

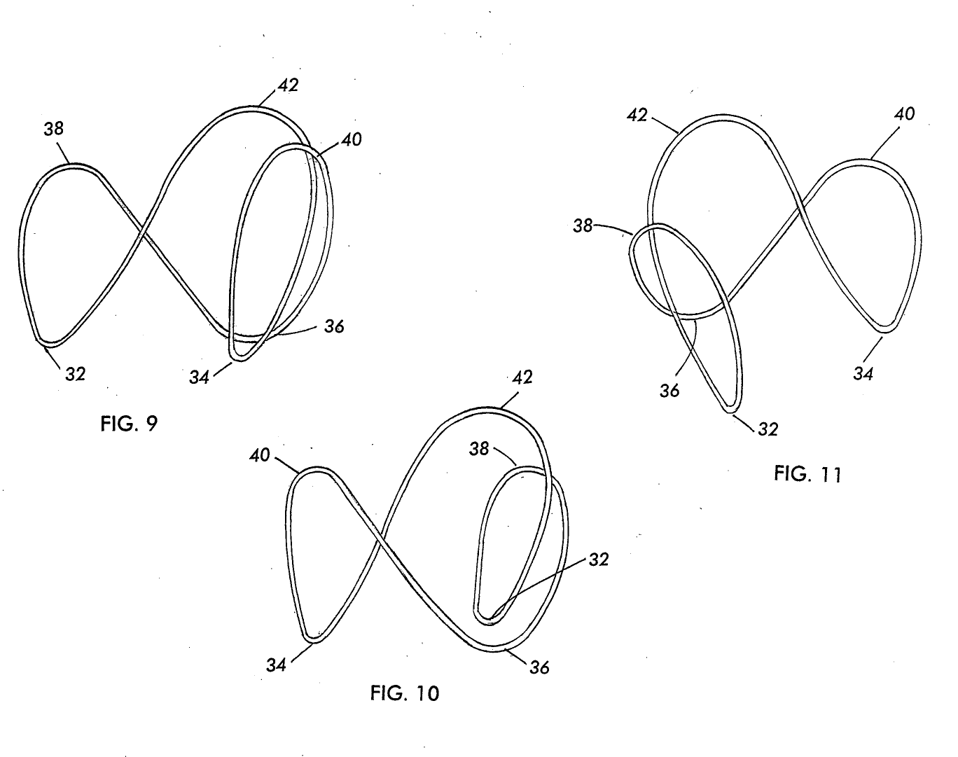

FIGS. 9, 10 and 11 show a further embodiment of the chair frame for a lounge chair with a lower back loop and a deeper seat area.

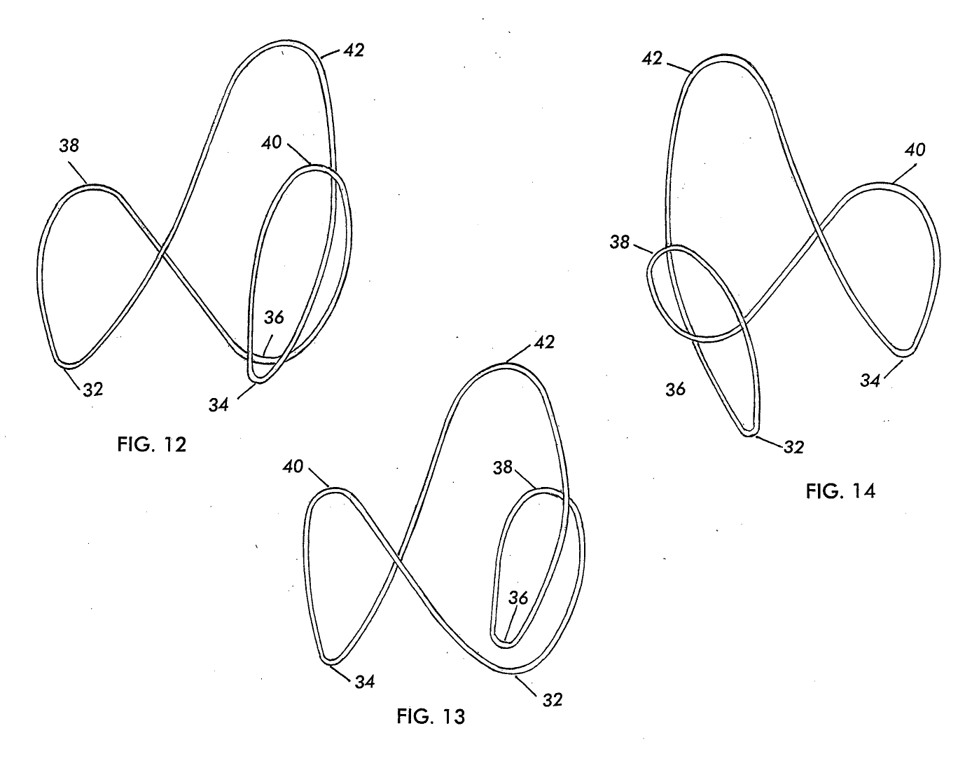

FIGS. 12, 13 and 14 show a still further embodiment for a lounge chair frame with a taller back.

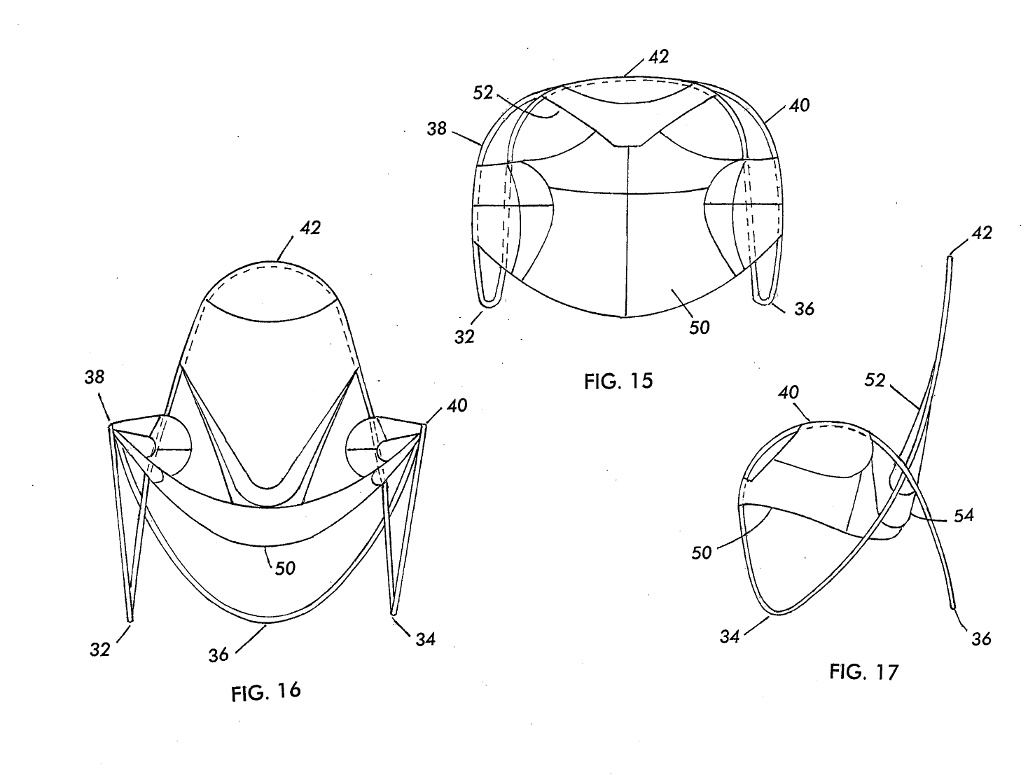

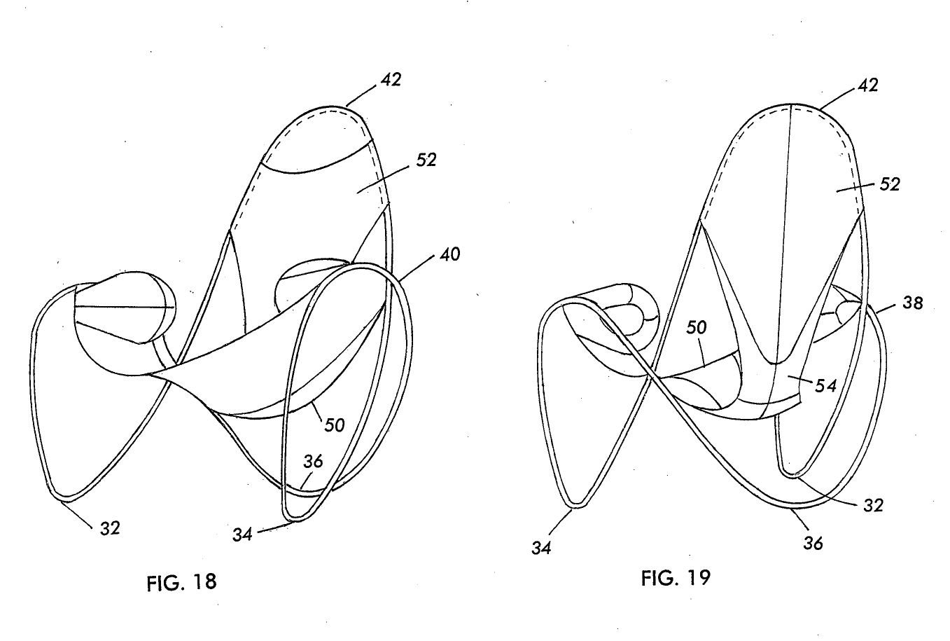

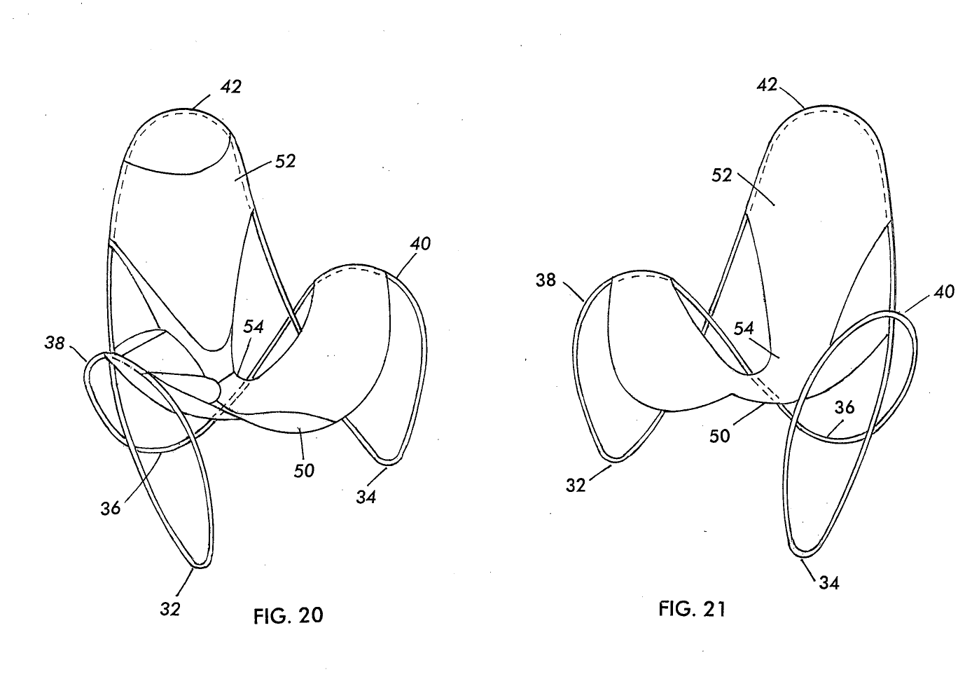

FIGS. 15 to 19 show a chair, which uses the frame of FIGS. 12 to 15. The chair is formed by fastening a seat fabric 50 and a back fabric 52 to the frame. Thus, fabric 50, which may be a cushioned pad is stretched across and is fastened to seat receiving loops 38 and 40. The seat fabric 50 may also have a tail 54 (FIGS. 17 and 19) which is attached to back fabric 52. The back fabric 52 is attached to loop 42.

The fabrics 50 and 52 may be fixed to their loops by snaps or by sewn flaps or the like.

Referring next to FIG. 21, the chair therein is similar to that of FIG. 18 except that the fabrics 50, 52 and 54 are formed of a rubber or leather base. Clearly any fabric desired can be used.

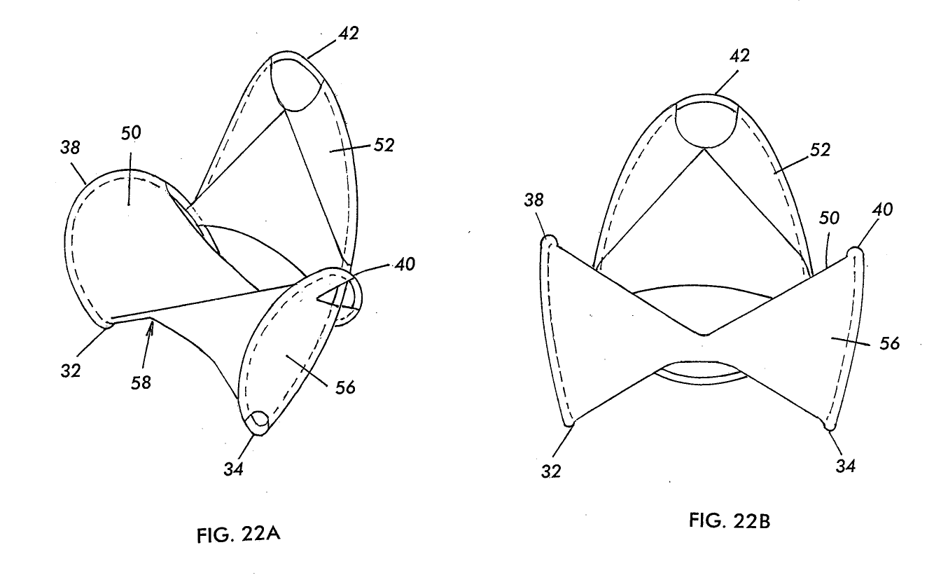

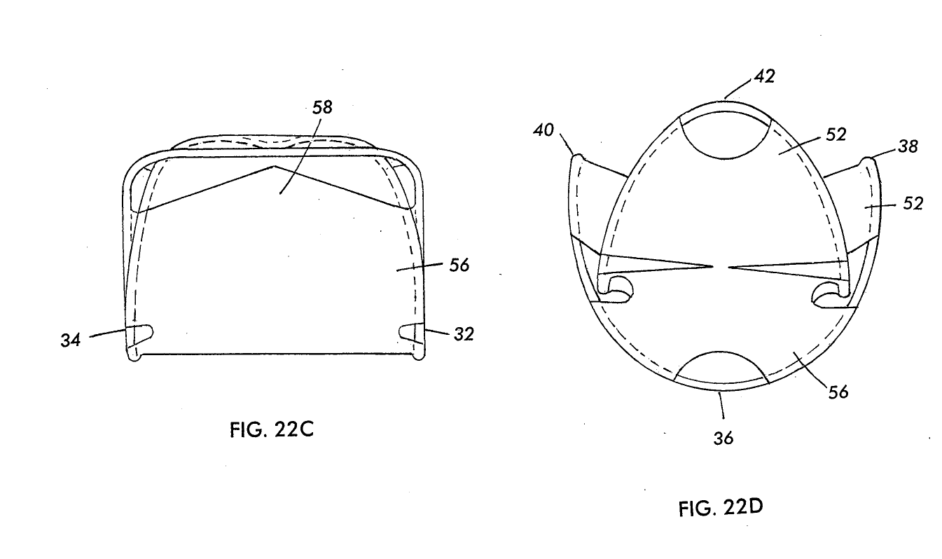

Referring to FIGS. 22A-22D, a chair according to another embodiment of the present invention may include a seat fabric 50 and a back fabric 52 which are not attached to one another by a tail fabric 54 or the like. Rather, tail 54, or an extension of the seat fabric 50 functioning as a tail portion, is attached to engaging loop 36 as illustrated by FIG. 22D. Thus, seat fabric 50 provides a seating area for both a user while back fabric 52 provides support for the back of the user. Note that in the embodiment shown by FIG. 22A, a bottom portion 56 of seat fabric 50 that is at the end opposite tail 54 extends below seat fabric 50 and is attached at the edges thereof to engaging loops 32, 34. According to an aspect of the present invention at least seat fabric 50 and bottom portion 56 may be made from a compliant, stretching material. According to another aspect of the present invention, the seat fabric 50 and bottom portion 56 thereof may be sewn (or coupled by other means) to one another along a center line 58 whereby the seat fabric 50 is stretched to provide additional mechanical rigidity to support the user.

A chair according to the embodiment disclosed by FIGS. 22A-22D minimizes fabrication expenses thus creating a more cost effective chair by creating two fabric halves of the seat and back. These sail like fabric pieces could have a sewed sleeved along the outer edges thereof so that they could be slid around the frame. Thereafter, seat fabric 50 and bottom portion 56 thereof would be sewn in the middle to put seat fabric 50 in tension, thus completing the chair. Seat fabric 50 is attached to the frame before the frame is welded together and finished, or seat frame 506 and back fabric 52 could be sewn to the finished frame. Alternatively, seat fabric 50 and back fabric 52 could be sleeved around the frames using Velcro or some other mechanical fastener.

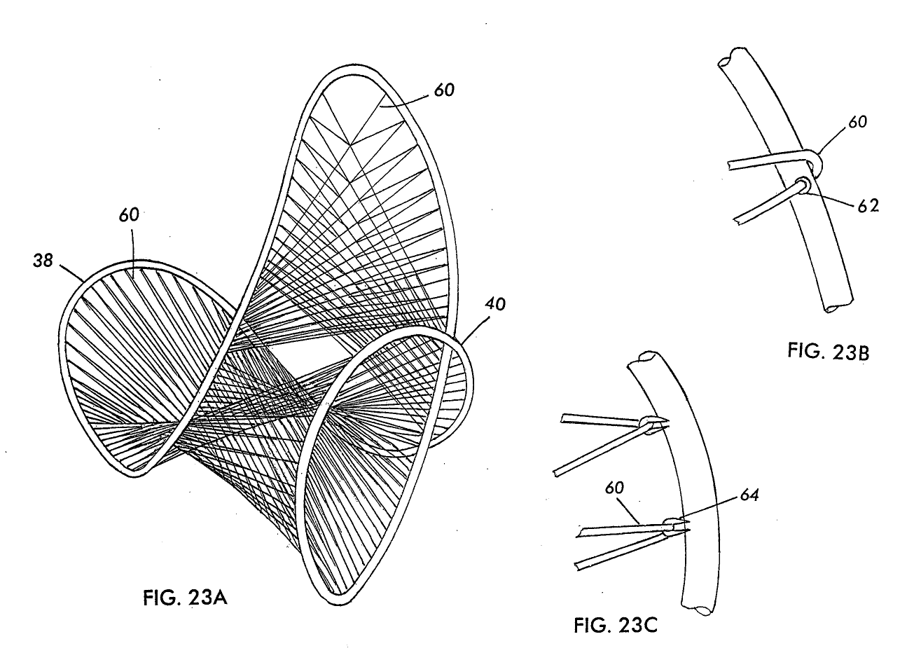

Referring to FIG. 23A, a chair according to another embodiment of the present invention may be realized without the use of a fabric for the seating support and the back support. Specifically, a cord 60 or the like may be used to construct a seat support between seat-receiving loops 38, 40 and a back support coupled to back supporting loop 42. Each seat support or back support would be realized by lacing a cord to create a net-like arrangement to provide support for seating between the seat receiving loops of the frame and provide back support for the back of the user disposed in the interior of the back receiving loop of the frame.

The composition of cord 60 is driven by comfort and aesthetics. There are alternative approaches to the fabrication of seat and back support. For example, the frame could be provided with a plurality of spaced holes 62 drilled into it at the precise locations for the receipt of cord 60 as illustrated by FIG. 23B. Then one long continuous cord would be laced through holes 62, similar to stringing a tennis racket. This technique requires two points of engagement with the frame as illustrated by FIG. 23B, one for entry of cord 60 and the other for its exit. Alternatively, only one point of connection to the frame can be provided. Specifically, for example, tiny metal loops 64 functioning as anchors could be pinned into the frame at the precise location for the receipt of cord 60 as illustrated by FIG. 23C. Tiny metal loops 64 would be similar in size and shape to half a small swivel. Then, cord 60 would be strung like a tennis racket.

Although the present invention has been described in relation to particular embodiments thereof, many other variations and modifications and other uses will become apparent to those skilled in the art. For example, other material besides metal can be used to form the furniture frame. It is preferred, therefore, that the present invention be limited not by the specific disclosure herein.

What is claimed is:

1. A chair frame formed from a continuous rod bent along its length to form a plurality of continuous loops; said plurality of continuous loops including at least three spaced floor engaging loops and first and second seat receiving loop and a back receiving loop.

2. The chair frame of claim 1, wherein said first ground engaging loop is disposed between said first seat receiving loop and one end of said back receiving loop; and wherein said second ground engaging loop is disposed between said second seat receiving loop and the other end of said back receiving loop; and wherein said third ground engaging loop is disposed between said first and second seat receiving loops.

3. The chair frame of claim 1, wherein said continuous rod is a single elongated metal tube.

4. The chair frame of claim 2, wherein said continuous rod is a single elongated metal tube.

5. The chair frame of claim 3, wherein said metal tube is a stainless steel tube of diameter greater than about ⅝ inch.

6. The chair frame of claim 3, wherein said metal tube is a stainless steel tube of diameter greater than about ⅝ inch.

7. The chair frame of claim 1, wherein said first and second seat receiving loops are disposed in spaced planes and are adapted to receive a flexible seating fabric stretched across the space between them.

8. The chair frame of claim 2, wherein said first and second seat receiving loops are disposed in spaced planes and are adapted to receive a flexible seating fabric stretched across the space between them.

9. The chair frame of claim 1, wherein said continuous rod is a single elongated metal tube.

10. The chair frame of claim 7, wherein said metal tube is a stainless steel tube of diameter greater than about ⅝ inch.

11. The chair frame of claim 7, wherein said back loop is adapted to receive a flexible back-receiving fabric.

12. A chair formed from a chair frame, a seating fabric and a back fabric; said chair frame formed from a continuous rod bent along its length to form a plurality of continuous loops; said plurality of continuous loops including at least three spaced floor engaging loops and first and second seat receiving loop and a back receiving loop; said seating fabric secured to said first and second seat receiving loops and stretched across the space between them; said back fabric being secured to and stretching across said back loop.

13. The chair frame of claim 12, wherein said first ground engaging loop is disposed between said first seat receiving loop and one end of said back receiving loop; and wherein said second ground engaging loop is disposed said second seat receiving loop and the other end of said back receiving loop; and wherein said third ground engaging loop is disposed between said first and second seat receiving loops.

14. The chair frame of claim 12, wherein said continuous rod is a single elongated metal tube.

15. The chair frame of claim 14, wherein said metal tube is a stainless steel tube of diameter greater than about ⅝ inch.

16. The process of forming a chair frame comprising the steps of bending a continuous tube to form a series of continuous loops, which form, in seriatim;
a first ground engaging loop;
a first seat receiving loop;
a second ground engaging loop;
a second seat receiving loop;
a third ground engaging loop;
and a back receiving loop which is joined with said first and third ground engaging loops.

17. The process of forming a chair, comprising the steps of bending a continuous tube to form a series of continuous loops which form, in seriatim;
a first ground engaging loop;
a first seat receiving loop;
a second ground engaging loop;
a second seat receiving loop;
a third ground engaging loop;
and a back receiving loop which is joined with said first and third ground engaging loops; and
thereafter securing the opposite sides of a seating fabric to said first and second loops respectively, and securing a back receiving fabric across the plane defined by said back receiving loop.

18. The chair of claim 1, further comprising a cord laced to realize a seat support between the first and second seat receiving loops.

19. The chair of claim 1, further comprising a cord laced to realize a back support.
